(19) United States
(12) Patent Application Publication
(10) Pub. No.: US 2017/0120669 A1
(43) Pub. Date: May 4, 2017

(54) 3D Graphic Rims

(71) Applicant: Joel D. Beasley, Jacksonville, NC (US)

(72) Inventor: Joel D. Beasley, Jacksonville, NC (US)

(21) Appl. No.: 14/927,846

(22) Filed: Oct. 30, 2015

(51) Int. Cl. B60B 1/06

(52) U.S. Cl. CPC B60B 1/06; B60B 2900/572

(57) ABSTRACT

The present invention provides a vehicle rim that has a three-dimensional design molded onto it. The designs include various themes, colors, and patterns to meet a person's style requirement. The vehicle rim may have a single design, or combinations of designs. In a preferred embodiment of the present invention, the vehicle rim is indented on the location where designs are molded so that the designs do not lie outside the outer plane of a tire. The present invention also provides a system and method that enable users to design and purchase vehicle rim made to their specification. The user can chose a design suiting their style and personality from different varieties shown in the GUI.

### (B) CROSS REFERENCE TO RELATED APPLICATIONS

Not applicable.

### (C) FEDERALLY SPONSORED RESEARCH AND DEVELOPMENT

Not applicable.

### (D) MICROFICHE APPENDIX

Not applicable.

### (E) BACKGROUND OF THE INVENTION

(1) Field of Invention

The present invention generally relates to a vehicle rim. More particularly, the present invention relates to “a vehicle rim that has a three-dimensional design molded onto it”.

(2) Background of Invention

Automobiles provide a person a way to express themselves and show their personality. People tend to style their automobile in the way that suits their personality. They tend to install personalized license plates, decorative lights, etc. onto their vehicle to make it appear stylish. Installing new designer wheels and rims also change the appearance of a vehicle. However, in terms of designs that are generally available for rims, the choice is very limited. A person has to generally choose from regular chrome plated rims, gold plated rims, polished aluminum rims, or black rims. There have been attempts at providing rims with decorative elements to provide a user with more options. For example, U.S. Pat. No. 4,682,820 A, issued to Motor Wheel Corporation on Jul. 28, 1987, discloses a styled wheel that includes an ornamental plastic overlay permanently afixed to the rim. Similarly, U.S. Pat. No. 5,316,376 A, issued to Defreitas Manuel P on May 31, 1994, discloses a vehicle wheel cover that clips onto a wheel rim. The cover has decorative indicia, including photographs or artwork. Also, U.S. Pat. No. 5,464,276 A, issued to Roderick L. Ott on Nov. 7, 1995, discloses a decorative accessory attached to the rim of a wheel. The accessory bears indicia, such as letters, words, logos, or other graphic designs. However, these rims do not provide sufficient choices to fulfill the needs of a person to use a rim with designs that matches their true personality. Hence, there is a need for vehicle rims with many varieties of beautiful designs that match the style requirements of different users. Furthermore, there is a need for a method to help a user to design and purchase a vehicle rim made to his/her specification.

It is an aspect of the invention to overcome or alleviate a problem of the prior art.

This permits the use of the present invention, which enhances the prior art of the vehicle rim for providing decorative elements to suit a person's style requirement.

### (F) BRIEF SUMMARY OF THE INVENTION

In view of the foregoing, one aspect of the various disclosed embodiments of the present invention is to provide a vehicle rim that has a three-dimensional design molded onto it. Another aspect is a system and method that enables users to design and purchase vehicle rims made to their specification.

Preferably, the vehicle rim with molded three-dimensional designs and the system and method address, or at least ameliorate, one or more of the problems described above. To this end, the present invention, related to a vehicle rim that has molded three-dimensional designs with some unique aspects, is disclosed.

Accordingly, it is a primary objective of the present invention to provide a vehicle rim with a three-dimensional design molded on it. The three-dimensional designs include various themes, colors, patterns, and combinations thereof. These three-dimensional designs are intended to allow the user to express himself/herself and style his/her vehicle according to his/her styling requirement.

It is another objective of the present invention that the vehicle rim meets automobile regulations.

It is still another objective of the present invention to provide a system and method that enable users to design and purchase vehicle rims made to their specification.

Other objectives of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its use, reference should be had to the accompanying drawings and descriptive matter, in which there are illustrated preferred embodiments of the invention.

### (G) BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 shows perspective view of a vehicle rim of an automotive vehicle;

FIG. 2 shows a front perspective view of an embodiment of a vehicle rim incorporating a butterfly and flowers design;

FIG. 3 shows a front perspective view of an embodiment of a vehicle rim incorporating a fish design;

FIG. 4 shows a front perspective view of an embodiment of a vehicle rim incorporating a snake design;

FIG. 5 shows a front perspective view of another embodiment of a vehicle rim incorporating a snake design;

FIG. 6 shows a front perspective view of an embodiment of a vehicle rim incorporating a deer antlers design;

FIG. 7 shows a front perspective view of an embodiment of a vehicle rim incorporating a skull design;

FIG. 8 shows a front perspective view of an embodiment of a vehicle rim incorporating a football helmet design;

FIG. 9 shows a front perspective view of an embodiment of a vehicle rim incorporating stars design;

FIG. 10 shows a front perspective view of another embodiment of a vehicle rim incorporating an American flag design;

FIG. 11 shows a perspective view of a GUI of a virtual retail shop;

### (H) DETAILED DESCRIPTION OF THE INVENTION

The following detailed description of the present invention enables teaching of the invention and its best, currently known embodiment. Those skilled in the art can understand that many changes can be made in the embodiments described while still obtaining the beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made, and may be desired in certain circumstances, and are part of the present invention. Thus, the following description is provided as illustrative of the principle of the present invention.

Embodiments of the present invention provide a vehicle rim that has a three-dimensional design molded on it, and a system and method that enables users to design and purchase vehicle rims made to their specification. Many varieties of three-dimensional designs are provided to allow a user to choose a vehicle rim with three-dimensional designs matching his personality and expressing his liking. Accordingly, the specific embodiments discussed herein are merely illustrative of specific manners in which to make and use this invention, and are not intended to represent an exhaustive list of all possible structures and processes of the present invention.

Embodiments of the vehicle rim are shown in the figures, and discussed below. While the structure and processes have been described with a certain degree of particularity, it is to be noted that many modifications may be made to the details of the structure and processes without departing from the spirit and scope of this disclosure. It is understood that the structure and processes are not limited to the embodiments set forth herein for purposes of exemplification.

Aspects of the present inventive subject matter are described with reference to the figures.

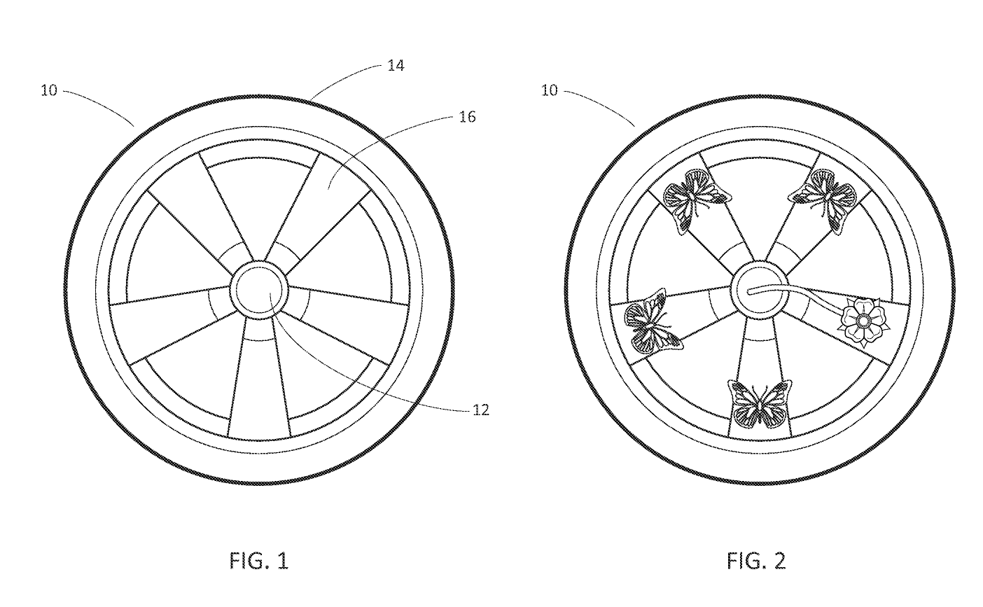

Referring to FIG. 1, a vehicle rim 10 consists of a hub 12, a circumferential member 14, and a support structure that extends radially outward from the hub 12 to the circumferential member 14. The support structure may be shaped differently. In a preferred embodiment of the present invention, the support structure is in form of circumferentially spaced spokes 16 that extend radially from the hub 12 to the circumferential member 14. The support structure may also be spoke-less, where the support structure extends around the hub 12 and extends radially outward to the circumferential member 14. The spokeless support structure may have different types of shaped holes, apertures, or open areas.

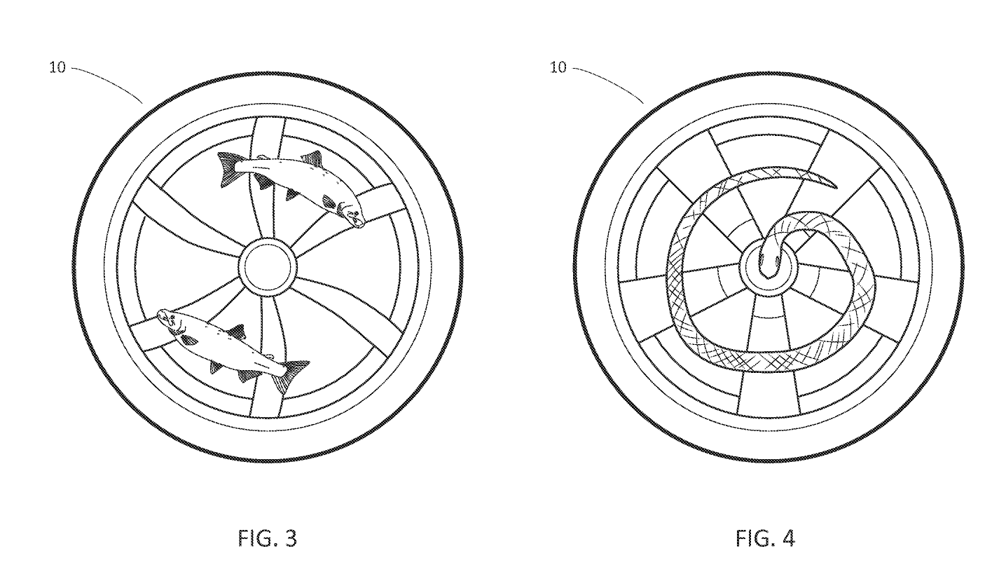

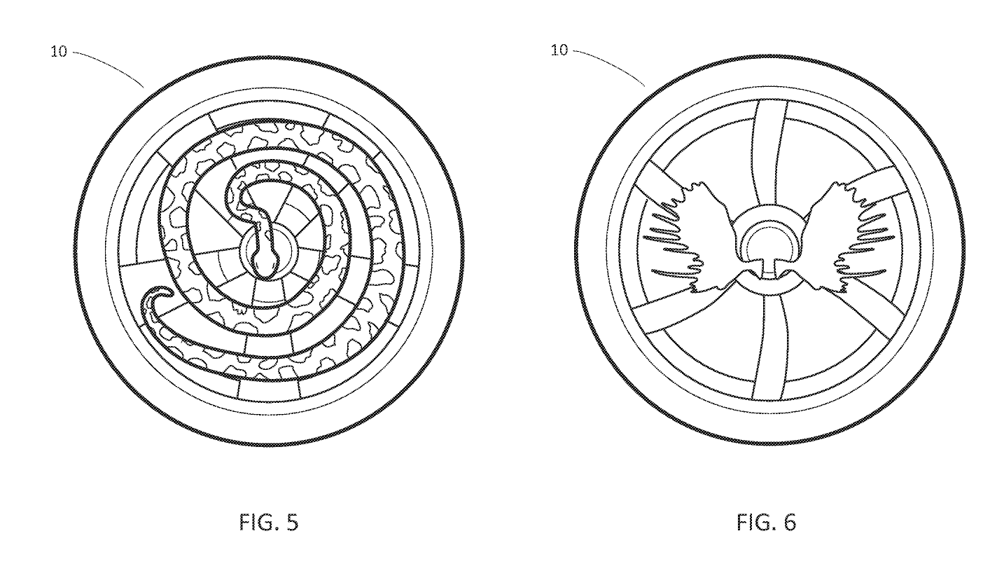

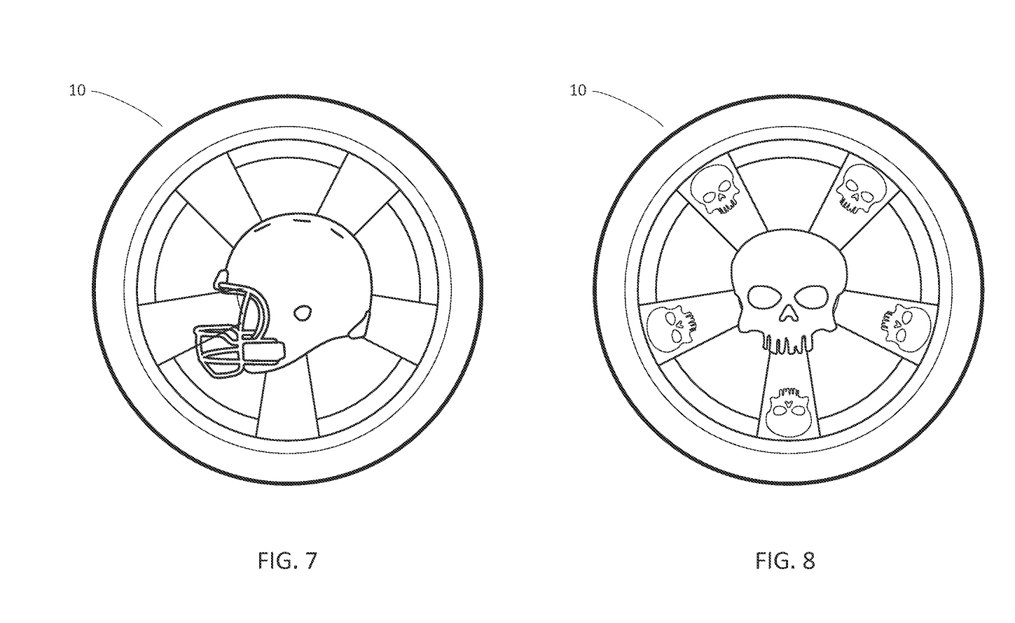

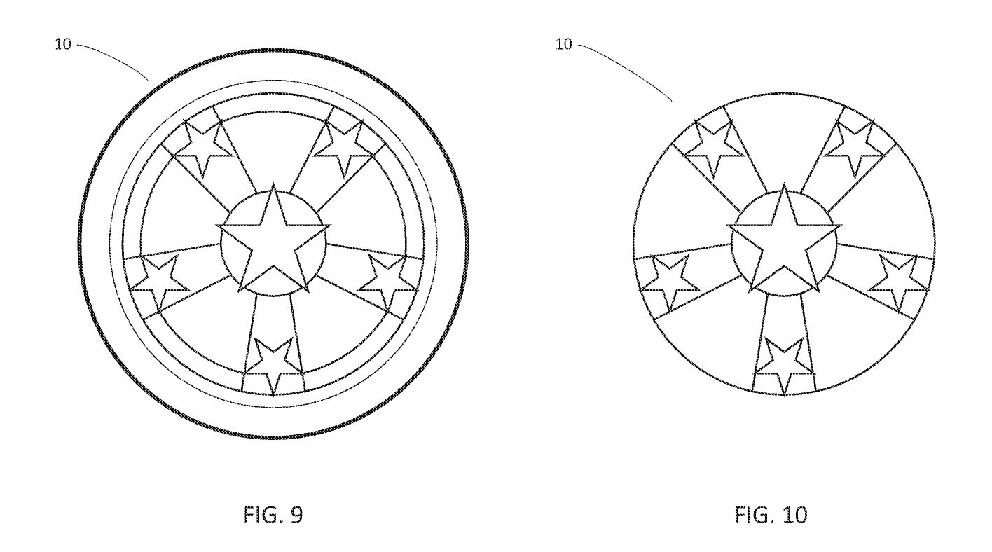

Referring to FIG. 2-10, the present invention provides a vehicle rim 10 that has three-dimensional designs molded on it. The three-dimensional designs on the vehicle rim are made by molding processes commonly known in the art. The three-dimensional designs may include various themes, colors, and patterns for providing a customized aesthetic appearance. Thus, the present invention allows a user to choose a vehicle rim matching his personality and allowing him/her to express himself/herself. The three-dimensional designs may include themes, including but not limited to animals (butterflies as shown in FIG. 2, fish as shown in FIG. 3, snake as shown in FIGS. 4 & 5, deer antlers as shown in FIG. 6), flowers (as shown in FIG. 2), nature, colors, favorite sports team (school, college, local or national sports team), sports items (basketball, soccer ball, baseball, football helmet as shown in FIG. 7, etc.) monetary symbol (dollar sign), food, skull (as shown in FIG. 8), bones, stars (as shown in FIG. 9), famous fictional characters, famous people and celebrities, cartoon characters, country symbol (flag colors and other elements, such as the American flag, as shown in FIG. 9), a company logo, or product brand. The vehicle rim may also include a combination of different three-dimensional designs. For example, a vehicle rim may have both butterfly and flower molded on it, as shown in FIG. 2. In a preferred embodiment, the vehicle rims are indented at the location of three-dimensional design molding, so that the moldings do not lie outside of the outer plane of a tire mounted on vehicle rim. The three-dimensional design molding will, thereby, meet automobile regulations.

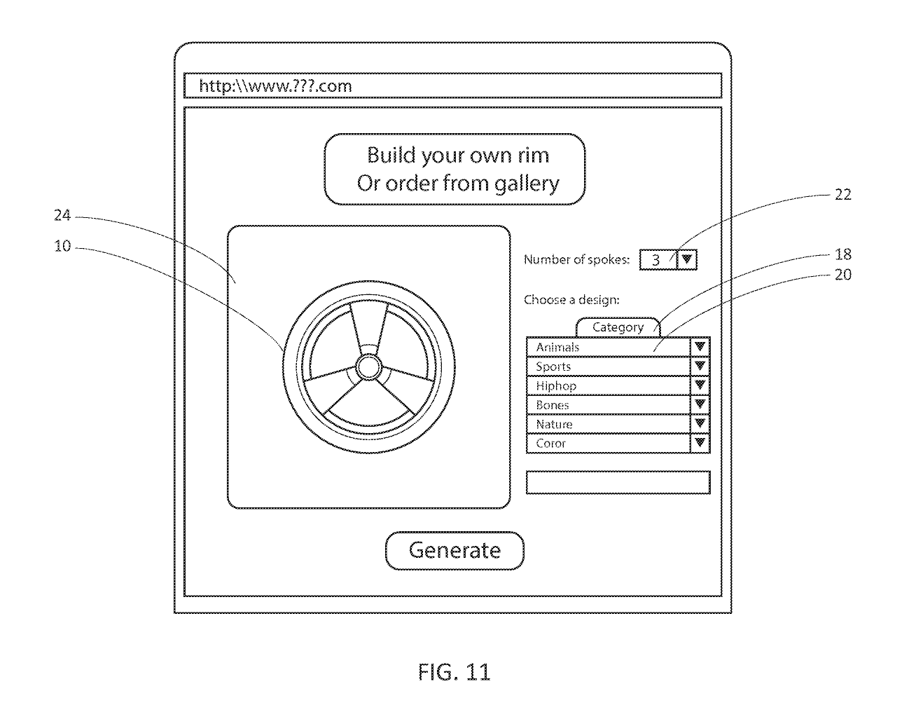

The present invention further provides a system and method that enables users to design and purchase vehicle rim made to their specification. The general operating environment of an embodiment of the present invention includes a virtual retail shop that is operated through a computer program located on a server. The server may be connected to a network, such as the Internet. A user may assess the graphic user interface (GUI) front end of the virtual retail shop through a service provider to the network using infrastructure that is currently well known in the art. The user may use his/her computer, laptop, or mobile devices for assessing the GUI of the virtual retail shop. Referring to FIG. 11, showing an exemplary representation of GUI of the virtual retail shop according to a preferred embodiment of the present invention, the GUI presents the user with options for three-dimensional designs under various categories 18. The three dimensional design options may include themes such as but not limited to animals, flowers, nature, colors, favorite sports team (school, college, local or national sports team), sports items (basketball, soccer ball, baseball, football helmet etc.) monetary symbol (dollar sign), food, skull, bones, stars, famous fictional character, famous people and celebrities, cartoon characters, country symbol (flag colors and other elements), a company logo, or product brand. These three-dimensional design options, on being selected, further generate a list of multiple subcategory three-dimensional design options to choose from. For example, animals theme 20 on being selected provides a dropdown list including but not limited to snake, butterfly, lion, tiger, panther, jaguar, dog, cat, elephant, eagle, fish, dragons, deer antlers, etc. Similarly, a monetary symbol theme presents dropdown list including but not limited to dollar sign ($), pound sign (£), euro sign ( [symbol] ), franc sign [symbol] ), yen sign (¥), etc. The GUI also presents the user with an option for the number of spokes 22 in the vehicle rim.

In a preferred embodiment, the GUI provides a display 24 showing the vehicle rim 10 with the chosen three-dimensional design applied on it. The program allows a user to drag and drop the chosen three-dimensional design on the display to apply the three-dimensional design on a vehicle rim to see how different three-dimensional designs will look on vehicle rim and then made a suitable choice. The user can also create combinations of the three dimensional design themes. If the user purchases a vehicle rim with three-dimensional designs according to his/her preference, the GUI presents a form to the user for entering information to pay for the selected vehicle rim using available e-commerce means. The purchased vehicle rim with selected three-dimensional design can be manufactured by suitable technical means and may be made on the vehicle rim using molding processes known in the art. The manufactured vehicle rim can then be delivered to the user. The present invention thus provides an easy way to review various three-dimensional design themes and three-dimensional design subcategories to select a three-dimensional design representing the user's personality and have it molded on a vehicle rim.

The present invention helps automobile enthusiasts to express themselves through vehicle rims that have three-dimensional designs matching their personality. An automobile owner can use these vehicle rims to enhance the looks of the automobile to suit his/her styling requirements. Sports enthusiasts are able to show their love for their favorite sports team in a unique and classy way. Similarly, a nature lover can express their liking by using vehicle rims with their favorite animal, flower, or the like. The present invention also provides a mean to promote a product or company by using vehicle rim having a company logo or product brand molded onto it. Another advantage is that the automobile enthusiasts can use their creativity by customizing their vehicle to express their liking.

The vehicle rim is made from a conventional metallic material. The vehicle rim can be provided in different sizes to match the wheel sizes of different vehicle make and models.

It is to be understood that the above description is intended to be illustrative, and not restrictive. For example, the above discussed embodiments may be used in combination with each other. Many other embodiments will be apparent to those of skill in the art upon reviewing the above description.

Whereas the construction and method have been described in relation to the figures of the drawings, it should be understood that other and further modifications, apart from those shown or suggested herein, may be made within the spirit and scope of this invention.

What is claimed is:

1. A vehicle rim comprising:
a hub;
a support structure;
a circumferential member; and
at least one three-dimensional design;
wherein said three-dimensional design is molded on said vehicle rim.

2. The vehicle rim of claim 1, wherein said at least one three-dimensional design includes themes, colors, and patterns providing an aesthetic appearance.

3. The vehicle rim of claim 1, wherein said at least one three-dimensional design includes themes selected from list including animals, flowers, nature, colors, favorite sports team, sports items, monetary symbol, food, skull, bones, stars, famous fictional character, famous people and celebrities, cartoon characters, country symbol, a company logo or product brand.

4. The vehicle rim of claim 1, wherein said vehicle rim is indented at location of said at least one three-dimensional design molding so that said at least one three-dimensional design molding does not lie outside of outer plane of a tire mounted on said vehicle rim.

5. The vehicle rim of claim 1, wherein said support structure includes at least three spokes.

6. The vehicle rim of claim 1, wherein said vehicle rim is made of metal.

7. A system for designing vehicle rim, the system comprising:
means for displaying available three-dimensional design categories for a vehicle rim to a user,
means for generating a list of multiple subcategory three-dimensional designs to allow a user select at least one subcategory three-dimensional design,
means for displaying available number of spokes for vehicle rim to a user to allow a user select number of spoke for said vehicle rim, and
means for generating a display showing selected at least one subcategory three dimensional design on vehicle rim comprising selected number of spokes.

8. The system of claim 7, further comprising means for purchasing the vehicle rim with three-dimensional design selected and finalized by the user, wherein said three-dimensional design is molded on said vehicle rim.

9. A method for designing vehicle rim, the method comprising the steps of:
displaying available three dimensional design categories for vehicle rim to a user;
receiving user selected three dimensional design;
generating a list of multiple subcategory three dimensional designs;
receiving user selected subcategory three-dimensional design; and
generating a display showing selected subcategory three-dimensional design on vehicle rim.

10. The method of claim 9, further comprising the step of purchasing the vehicle rim with three-dimensional design selected and finalized by the user, wherein said three-dimensional design is molded on said vehicle rim.

11. The method of claim 9, wherein said at least one three dimensional design include themes selected from list including animals, flowers, nature, colors, favorite sports team, sports items, monetary symbol, food, skull, bones, stars, famous fictional character, famous people and celebrities, cartoon characters, country symbol, a company logo or product brand.

12. A computer program product for designing vehicle rim, the computer program product comprising:
computer code that displays available three dimensional design categories for vehicle rim to a user;
computer code that generates a list of multiple subcategory three dimensional designs to allow a user selects at least one subcategory three dimensional design;
computer code that displays available number of spokes for vehicle rim to a user to allow a user select number of spoke for said vehicle rim; and
computer code that generates a display showing selected at least one subcategory three dimensional design on vehicle rim comprising selected number of spokes.

13. The computer program product of claim 12, further comprising computer code that enables the user to purchase the vehicle rim with three dimensional design selected and finalized by the user wherein said three dimensional design is molded on said vehicle rim.
